(19) United States
(12) Patent Application Publication
(10) Pub. No.: US 2026/0249170 A1
(43) Pub. Date: Aug. 27, 2026

(54) GAME INTERACTION METHOD AND APPARATUS, AND ELECTRONIC DEVICE

(71) Applicant: NETEASE (HANGZHOU) NETWORK CO., LTD., Hangzhou (CN)

(72) Inventor: Haoqi MIAO, Hangzhou (CN)

(21) Appl. No.: 18/877,894

(22) PCT Filed: Nov. 3, 2022
(86) PCT No.: PCT/CN2022/129529

§ 371 Date: Dec. 20, 2024

(30) Foreign Application Priority Data
Jun. 29, 2022 (CN) 202210758918.7

(51) Int. Cl. A63F 13/2145; A63F 13/533; A63F 13/57

(52) U.S. Cl. CPC A63F 13/2145; A63F 13/533; A63F 13/57

(57) ABSTRACT

The present disclosure provides a game interaction method. The method includes: in response to a first touch operation for a first virtual joystick, controlling a virtual character to move in a virtual scene; in response to determining that a position relationship between the virtual character and a virtual bunker meets a preset condition, displaying a crouch control in a graphical user interface; in response to a second touch operation for the crouch control, controlling the virtual character to enter the virtual bunker and crouch within the virtual bunker, and displaying a second virtual joystick in the graphical user interface; and, in response to a third touch operation for the second virtual joystick, controlling the virtual character to move in a crouching state.

### CROSS-REFERENCE TO RELATED APPLICATIONS

The present disclosure is a 371 national phase application of PCT Application No. PCT/CN2022/129529 filed Nov. 3, 2022, which claims priority to Chinese Patent Application 202210758918.7, entitled “GAME INTERACTION METHOD AND APPARATUS, AND ELECTRONIC DEVICE” filed on Jun. 29, 2022, the entire contents of both of which are hereby incorporated by reference for all purposes.

### TECHNICAL FIELD

The present disclosure relates to the technical field of game interaction, and particularly relates to a game interaction method and apparatus, and an electronic device.

### BACKGROUND

In games with bunker shooting as the main mode of combat, there are frequent and diverse interactions between players and bunkers. It is also an important part of the core combat experience throughout the game. Controlling characters to enter and leave bunkers and moving the characters in and out of the bunkers are core parts of players' game experience. In related technologies, the guidance of operating and moving joysticks to make the character in the bunker to move out of the bunker is not clear enough, and the same joystick operation has different responses when the character is in different orientations, which causes cognitive and operational burdens on players.

### SUMMARY

The present disclosure provides a method, apparatus, and an electronic device for game interaction, configured to prevent player misoperations or invalid actions while improving convenience and interaction efficiency in bunker-related interactions.

According to a first aspect, the present disclosure provides a game interaction method. The method includes: in response to a first touch operation for a first virtual joystick, controlling a virtual character to move in a virtual scene, where a graphic user interface of a terminal device displays at least one of the virtual scene and the first virtual joystick, and the virtual scene includes the virtual character and a virtual bunker; in response to determining that a position relationship between the virtual character and the virtual bunker meets a preset condition, displaying a crouch control in the graphical user interface; in response to a second touch operation for the crouch control, controlling the virtual character to enter the virtual bunker and crouch within the virtual bunker, and displaying a second virtual joystick in the graphical user interface; and, in response to a third touch operation for the second virtual joystick, controlling the virtual character to move in a crouching state.

According to a second aspect, the present disclosure provides a system, comprising one or more memories collectively containing one or more programs, and one or more processors, where the one or more processors are configured to, individually or collectively, perform the operations described in the above game interaction method. According a third aspect, the present disclosure provides one or more non-transitory computer-readable storage media containing, in any combination, computer program code that, when executed by a computer system, performs the operations described in the above game interaction method.

### BRIEF DESCRIPTION OF THE DRAWINGS

FIG. 1 is a flowchart of one game interaction method provided by an embodiment of the present disclosure;

FIG. 2 is a flowchart of another game interaction method provided by an embodiment of the present disclosure;

FIG. 3 is a schematic diagram of displaying a crouch control provided by an embodiment of the present disclosure;

FIG. 4 is a schematic diagram of displaying a second virtual joystick provided by an embodiment of the present disclosure;

FIG. 5 is a flowchart of another game interaction method provided by an embodiment of the present disclosure;

FIG. 6 is a schematic structural diagram of a game interaction apparatus provided by an embodiment of the present disclosure; and

FIG. 7 is a schematic structural diagram of an electronic device provided by an embodiment of the present disclosure.

### DETAILED DESCRIPTION

For the purpose of making objects, technical schemes and advantages of embodiments of the present disclosure more clear, clear and complete description will be made to the technical solutions in the embodiments of the present disclosure with reference to accompanying drawings in the embodiments of the present disclosure. Definitely, the described embodiments are merely a part of the embodiments of the present discourse and not all the embodiments. The components of the embodiments of the present disclosure, as generally described and illustrated in the accompanying drawings, can be arranged and designed in a variety of different configurations.

Therefore, the following detailed description of the embodiments of the present disclosure provided in the accompanying drawings is not intended to limit the scope of the claimed present disclosure, but merely indicates selected embodiments of the present disclosure. Based on the embodiments in the present disclosure, all other embodiments obtained by those of ordinary skill in the art without creative labor fall within the scope of protection of the present disclosure.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The disclosed method, apparatus, and electronic device for object selection operate as follows: control, in response to a first touch operation for a first virtual joystick, the virtual character to move in a virtual scene, where a graphic user interface of a terminal device displays at least one of the virtual scene and the first virtual joystick, and the virtual scene includes the virtual character and a virtual bunker; in response to determining that a position relationship between the virtual character and the virtual bunker meets the preset condition, display the crouch control in the graphical user interface; in response to a second touch operation for the crouch control, control the virtual character to enter the virtual bunker and crouch within the virtual bunker; display a second virtual joystick in the graphical user interface; and in response to a third touch operation for the second virtual joystick, control the virtual character to move in a crouching state. In the disclosed embodiments, the first virtual joystick controls the virtual character to move in the standing state, while the second virtual joystick allows the virtual character to move around the virtual bunker in the crouching state. When the virtual character's position or orientation relative to the virtual bunker changes, the operation responses of the first virtual joystick and the second virtual joystick remain consistent. This consistency helps to prevent misoperations or invalid operations of the player and improve the convenience and interaction efficiency in bunker-related interactions.

Other features and advantages of the present disclosure will be described in the subsequent description, or, some of them may be inferred from the description or may be determined without doubt, or may be learned by practicing the above technology of the present disclosure.

In order to make the above objective, features and advantages of the present disclosure more obvious and easy to understand, preferred embodiments will be described in detail below with reference to the accompanying drawings.

In games with bunker shooting as the main mode of combat, there are frequent and diverse interactions between players and bunkers. It is also an important part of the core combat experience throughout the game. Controlling characters to enter and leave bunkers and moving the characters in and out of the bunkers are core parts of players' game experience.

In related technology, when the game character is close to the bunker, a crouch button will pop up on a main interface of the game, the player can click the crouch button to crouch behind the bunker, and then slide the joystick to control the character to move near the bunker, and click the crouch button again or slide the joystick to move the character in a direction opposite to the bunker, thus the character can leave the bunker and enters a standing state. For example, if the character is in a crouching state facing the bunker, the character does not respond when the joystick is slid forwards, the joystick is slid left or right to control the character to move in the corresponding direction, and the joystick is slid backwards to make the character enter the standing state. If the player adjusts the angle of view of the character and makes the bunker at the right of the player, the joystick can be slid left to make the character enter the standing state. Therefore, in this way, when the position or orientation of the character relative to the bunker is different, the response caused by the same joystick operation is different, the player is prone to misoperation or invalid operation, and it is easy to cause cognitive and operational burdens on the player, resulting in low convenience and interaction efficiency of the interaction operation related to the bunker.

On the basis of the above problems, the embodiments of the present disclosure provide a game interaction method and apparatus, and an electronic device. The technologies can be applied to games taking bunker shooting as the main mode of combat, scenes where there is an interaction between the player and the bunker, and particularly scenes where the player controls the virtual character to enter and leave the bunker and moves the virtual character in and out of the bunker.

The game interaction method according to one embodiment of the present disclosure can be operated on a terminal device or a server. The terminal device can be a local terminal device. When the game interaction method is operated on a server, the method can be realized and executed based on a cloud interaction system, and the cloud interaction system includes the server and a client device.

In one embodiment, various cloud applications can be operated in the cloud interaction system, such as cloud games. Taking a cloud game as an example, the cloud game refers to a game mode based on cloud computing. Under the operation mode of a cloud game, an operation subject of a game program and a game picture presentation subject are separated, the storage and operation of an information interaction method are implemented in a cloud game server, and the client device is configured to receive and send data and present game pictures. For example, the client device can be a display device which is close to a user and has a data transmission function, such as a mobile terminal, a television, a computer and a palmtop; however, the terminal device for information processing is the cloud game server at a cloud end. When playing a game, the player operates the client device to send an operation instruction to the cloud game server, then the cloud game server runs the game according to the operation instruction, data such as the game pictures are encoded and compressed and returned to the client device through a network, and finally the game pictures are decoded and outputted through the client device.

In one embodiment, the terminal device can be a local terminal device. Taking a game as an example, the local terminal device stores the game program and is configured to present the game picture. The local terminal device is configured to interact with the player through a graphical user interface, namely, the game program is downloaded, installed and operated through an electronic device conventionally. The local terminal device provides the graphical user interface for the player in various modes, such as rendering and displaying it on the terminal's display screen, or providing it to players through holographic projection. For example, the local terminal device may include a display screen and a processor, the display screen is configured to present the graphical user interface, the graphical user interface includes the game picture, and the processor is configured to run the game, generate the graphical user interface and control the display of the graphical user interface on the display screen.

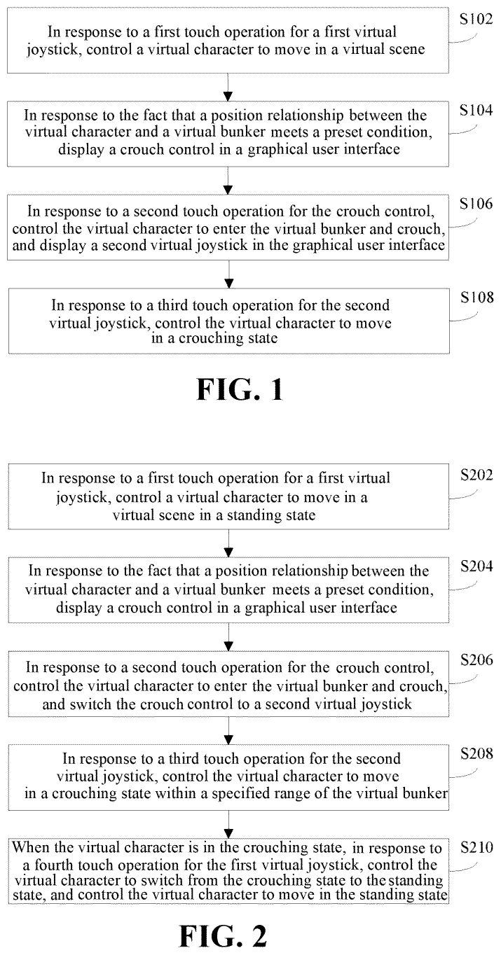

In a possible embodiment, an embodiment of the present disclosure provides a game interaction method; a graphic user interface is provided by means of a terminal device and displays at least part of a virtual scene and a first virtual joystick as well as a virtual character and a virtual bunker in the virtual scene; as shown in FIG. 1, the method includes the following specific steps:

Step S102: In response to a first touch operation for the first virtual joystick, control the virtual character to move in the virtual scene.

The virtual character is a virtual character controlled by the player in the game, and the player can control the virtual character to move, switch postures, attack and defense in the game scene. In one embodiment, when the virtual character is far away from the virtual bunker, the player can operate the first virtual joystick to control the virtual character to move in the game scene, and at the moment, the virtual character is usually kept in a standing state in the moving process.

The touch operation for the first virtual joystick can be a sliding operation of the player for a second virtual joystick, and can also be a dragging operation of the player for the second virtual joystick; and the specific trigger operation mode can be set according to research and development requirements.

Step S104: In response to the fact that a position relationship between the virtual character and the virtual bunker meets a preset condition, display a crouch control in the graphical user interface.

The preset condition can be set according to the research and development requirements. For example, the preset condition can be that the distance between the virtual character and the virtual bunker reaches a preset distance value, and the preset distance value may be 2 m, 3 m or 5 m; and the preset condition may also be that the virtual character reaches a certain fixed position near the virtual bunker.

In the process when the player controls the virtual character to move, if the position relationship between the virtual character and the virtual bunker meets the preset condition, a crouch control will be displayed in the graphical user interface, and the virtual character can be controlled to enter a crouching state by operating the crouch control. Specifically, the crouch control can be displayed at the left or right of the graphical user interface or other positions which do not hinder the vision of the player in the game.

Step S106: In response to a second touch operation for the crouch control, control the virtual character to enter the virtual bunker and crouch, and display the second virtual joystick in the graphical user interface.

In one embodiment, the second touch operation of the player for the crouch control can be a click operation of the player for the crouch control, or a sliding operation of the player for the crouch control, or a dragging operation of the player for the crouch control, and the like; and the specific operation mode can be set according to the research and development requirements, and specific limitation is not made here.

When the player touches the crouch control, the virtual character will hide at a certain position near the virtual bunker in the crouching state, the position can be the rear side, left side or right side of the virtual bunker, and the like, and the position is specifically determined according to the current position of the virtual character and the position of the virtual bunker. For example, if the virtual bunker is on the right side of the virtual character, the position is the position on the left side of the virtual bunker; and if the virtual bunker is located in front of the virtual character, the position is the position on the rear side of the virtual bunker.

When the player touches the crouch control, the virtual character will step in the crouching state and hide near the virtual bunker, and the second virtual joystick will also be displayed in the graphical user interface; and the second virtual joystick is mainly configured to control the virtual character to move in the crouching state, namely, it controls the virtual character to move around the virtual bunker in the crouching state. Specifically, the second virtual joystick can be independently used as a control to be displayed at a certain position of the graphical user interface; or, an original crouch control can be changed into the second virtual joystick, where the second virtual joystick is displayed at a display position of the crouch control; or, the second virtual joystick can be displayed on the outer side of the crouch control so as to display the two crouch controls and the second virtual joystick together.

Step S108: In response to a third touch operation for the second virtual joystick, control the virtual character to move in the crouching state.

The touch operation for the second virtual joystick can be a sliding operation of the player for the second virtual joystick, or a dragging operation of the player for the second virtual joystick; and the specific triggering operation mode can be set according to the research and development requirements. In one embodiment, when the player performs a triggering operation on the second virtual joystick, the virtual character can be controlled to move within a specified range of the virtual bunker in the crouching state, and specifically, the virtual character can be controlled to move forward, backward, left, and right within the specified range of the virtual bunker in the crouching state. The specified range generally refers to a certain range near the virtual bunker. For example, the specified range may be a range having a distance from the virtual bunker smaller than a first distance threshold value, the first distance threshold value may be set according to the research and development requirements, and the specified range may also be an area around the virtual bunker.

Moreover, no matter how the player operates the second virtual joystick, the virtual character can only move within the specified range of the virtual bunker, and the virtual character cannot leave the virtual bunker. In this way, no matter where the virtual character is located or in any orientation relative to the virtual bunker, the responses caused by the operation of the player for the first virtual joystick and the second virtual joystick are the same, so that the cognitive and operational burdens on the player are reduced, and the mode of controlling the virtual character to move is clearer.

In the game interaction method provided by the embodiments of the present disclosure, in response to the first touch operation for the first virtual joystick, the virtual character is first controlled to move in the virtual scene; then, in response to the fact that the position relationship between the virtual character and the virtual bunker meets the preset condition, the crouch control is displayed in the graphical user interface; in response to the second touch operation for the crouch control, the virtual character is controlled to enter the virtual bunker and crouch, and the second virtual joystick is displayed in the graphical user interface; and in response to the third touch operation for the second virtual joystick, the virtual character is controlled to move in the crouching state. In this way, the virtual character is controlled by means of the first virtual joystick to move in the standing state, and is controlled by means of the second virtual joystick to move around the virtual bunker in the crouching state; when the position or orientation of the virtual character relative to the virtual bunker is changed, operation responses of the first virtual joystick and the second virtual joystick are not changed. Therefore, a misoperation or invalid operation of the player is avoided, and the convenience and interaction efficiency for the player to perform an interaction operation related to the bunker are improved.

The embodiments of the present disclosure further provide another game interaction method; the method is implemented on the basis of the above embodiment and focuses on the specific process of in response to the first touch operation for the first virtual joystick, controlling the virtual character to move in the virtual scene (implemented by the following step S202), the specific process of in response to the second touch operation for the crouch control, controlling the virtual character to enter the virtual bunker and crouch, and displaying the second virtual joystick in the graphical user interface (implemented by the following step S206), and the specific process of in response to the third touch operation for the second virtual joystick, controlling the virtual character to move in the crouching state (implemented by the following step S208). As shown in FIG. 2, the method includes the following specific steps:

Step S202: In response to a first touch operation for the first virtual joystick, control the virtual character to move in the virtual scene in a standing state.

If the virtual character is far away from the virtual bunker, the player can perform the first touch operation on the first virtual joystick to control the virtual character to move in the standing state. In some embodiments, the first touch operation can be a sliding operation; at the moment, the player can slide the first virtual joystick leftwards to move the virtual character leftwards in the standing state; the player can slide the first virtual joystick rightwards to move the virtual character rightwards in the standing state; the player can slide the first virtual joystick upwards to move the virtual character upwards in the standing state; and the player can slide the first virtual joystick downwards to move the virtual character downwards in the standing state.

Step S204: In response to the fact that a position relationship between the virtual character and the virtual bunker meets a preset condition, display a crouch control in the graphical user interface.

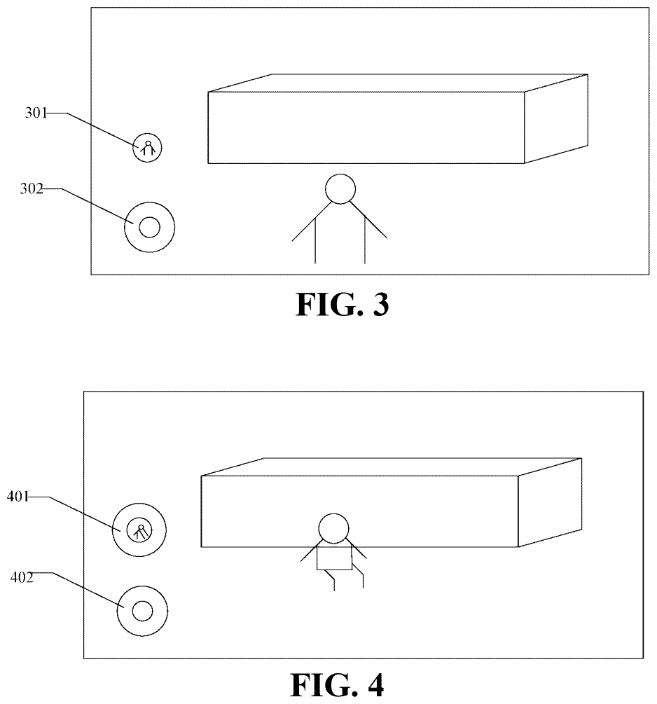

FIG. 3 is a schematic diagram of displaying a crouch control provided by an embodiment of the present disclosure; and in FIG. 3, a cuboid represents the virtual bunker, a control (namely, a control corresponding to a label 302 in FIG. 3) with a control rod in the middle of a circular base (equivalent to a joystick base) represents the first virtual joystick, and a control (namely, a control corresponding to a label 301 in FIG. 3) with a character identifier in the middle of a circle represents the crouch control.

In one embodiment, the crouch control is hidden in response to the fact that the position relationship between the virtual character and the virtual bunker does not meet the preset condition. When the position relationship between the virtual character and the virtual bunker does not meet the preset condition, the crouch control is not displayed in the graphical user interface.

Step S206: In response to a second touch operation for the crouch control, control the virtual character to enter the virtual bunker and crouch, and switch the crouch control into a second virtual joystick.

In one embodiment, the player performs the second touch operation (the second touch operation can be a click operation) on the crouch control, then the virtual character can be controlled to switch into the crouching state from the standing state, and the virtual character crouches on the rear side of the virtual bunker to hide himself. When the player performs the click operation on the crouch control, the crouch control may be switched into the second virtual joystick, such that the crouch control is changed into a crouching moving joystick, and the player may slide the joystick to control the virtual character to move around the virtual bunker in the crouching state.

In one embodiment, the second virtual joystick includes a joystick base and a control rod, in which the crouch control serves as the control rod, and specifically, the control rod is dragged to slide on the joystick base (the joystick base can correspondingly move or be fixed) to control the virtual character to move. FIG. 4 is a schematic diagram of displaying a second virtual joystick provided by an embodiment of the present disclosure; in FIG. 4, a cuboid represents the virtual bunker, the control with a control rod in the middle of a circular base (equivalent to the joystick base) (namely, a control corresponding to a label 402 in FIG. 4) represents the first virtual joystick, and the control with a character identifier displayed on the control rod in the middle of the circular base (namely, a control corresponding to a label 401 in FIG. 4) represents the second virtual joystick. The first virtual joystick and the second virtual joystick in FIG. 4 perform corresponding functions to control the virtual character to move in the standing state and move in the crouching state respectively, so that the moving operations for the virtual character in the crouching state and the standing state do not interfere with each other, they are clear and easy to understand, and the experience and efficiency of the player in interaction with the bunker are improved.

In one embodiment, the first virtual joystick and the second virtual joystick can be displayed on the same side of the graphical user interface. In some embodiments, the first virtual joystick and the second virtual joystick may also be displayed on different sides of the graphical user interface.

Step S208: In response to a third touch operation for the second virtual joystick, control the virtual character to move in the crouching state within a specified range of the virtual bunker.

In one embodiment, when the player performs a touch operation on the second virtual joystick, the virtual character can be controlled to move within a specified range of the virtual bunker in the crouching state, and specifically, the virtual character can be controlled to move forward, backward, left, and right within the specified range of the virtual bunker in the crouching state. The specified range generally refers to a certain range near the virtual bunker. For example, the specified range may be a range having a distance from the virtual bunker smaller than a first distance threshold value, the first distance threshold value may be set according to the research and development requirements, and the specified range may also be an area around the virtual bunker.

The third touch operation can be a sliding operation, so the player can slide the second virtual joystick to control the virtual character to move in the crouching state within the specified range of the virtual bunker. For example, the player can slide the second virtual joystick leftwards to move the virtual character leftwards in the crouching state; the player can slide the second virtual joystick rightwards to move the virtual character rightwards in the crouching state; the player can slide the second virtual joystick upwards to move the virtual character upwards in the crouching state; and the player can slide the second virtual joystick downwards to move virtual character downwards in the crouching state.

Step S210: When the virtual character is in the crouching state, in response to a fourth touch operation for the first virtual joystick, control the virtual character to switch from the crouching state to the standing state, and control the virtual character to move in the standing state.

The fourth touch operation can be a sliding operation of the player for the second virtual joystick, or a dragging operation of the player for the second virtual joystick, and the specific triggering operation mode can be set according to the research and development requirements. When the virtual character is in the crouching state, the player can trigger the first virtual joystick to immediately switch the virtual character from the crouching state to the standing state and move in the standing state according to the triggering operation for the first virtual joystick. It is also to be understood that when the virtual character is in the crouching state, and if the player operates the first virtual joystick, the virtual character is immediately released from the crouching state and starts to stand and move.

In some embodiments, the second virtual joystick is hidden in response to the fact that the virtual character is switched from the crouching state to the standing state. Specifically, when the virtual character is in the crouching state, the player can operate the first virtual joystick to cancel the display of the second virtual joystick in the graphical user interface, and the crouch control will be displayed at the display position of the second virtual joystick. When the virtual character is away from the virtual bunker, display of the crouch control will be canceled in the graphical user interface, so that the display space can be saved, interference of control display to the player is reduced, and the player can play the game more focused.

According to the game interaction method, the two joysticks are configured to control the movement of the virtual character in the standing state and the bunker crouching state respectively, so that the movement operations for the virtual character outside the bunker and near the bunker are clear and easy to understand; and moreover, the operation for a controlled virtual character in the crouching state is smoother when the controlled virtual character leaves the bunker to stand and move, and therefore, the game experience of the player can be improved.

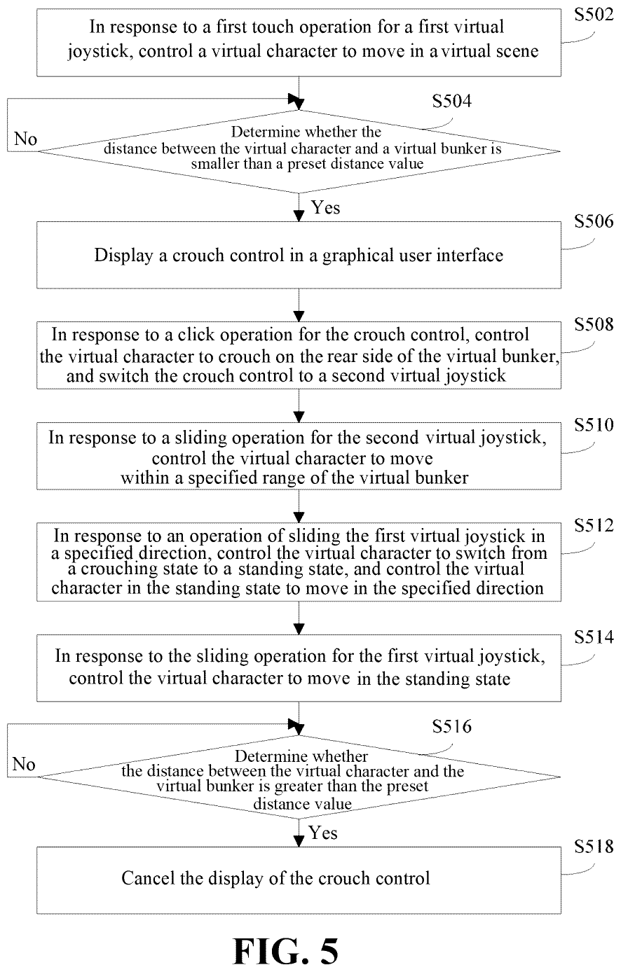

The embodiments of the present disclosure further provide another game interaction method, which is implemented on the basis of the above embodiments, as shown in FIG. 5, the method includes the following specific steps:

Step S502: In response to a first touch operation for a first virtual joystick, control a virtual character to move in a virtual scene.

Step S504: Determine whether the distance between the virtual character and a virtual bunker is smaller than a preset distance value; if it is smaller than the preset distance value, perform step S506; otherwise, proceed to step S504.

When the player performs a sliding operation on the first virtual joystick, the distance between the virtual character and the virtual bunker will be calculated, and whether the distance is smaller than the preset distance value will be determined; if the distance is smaller than the preset distance value, the crouch control will be displayed in the graphical user interface; if the distance is not smaller than a preset distance threshold value, whether the distance between the virtual character and the virtual bunker is smaller than the preset distance value is continuously determined so as to monitor the distance between a controlled object and the virtual bunker; and when the distance is smaller than the preset distance value, the crouch control will be displayed. The preset distance threshold value can be set according to the research and development requirements. For example, the preset distance threshold value can be set to be 2 m, 3 m or 5 m.

Step S506: Display a crouch control in the graphical user interface.

Step S508: In response to a click operation for the crouch control, control the virtual character to crouch on the rear side of the virtual bunker, and switch the crouch control to a second virtual joystick.

Step S510: In response to a sliding operation for the second virtual joystick, control the virtual character to move within a specified range of the virtual bunker.

Step S512: In response to an operation of sliding the first virtual joystick in a specified direction, control the virtual character to switch from the crouching state to the standing state, and control the virtual character in the standing state to move in the specified direction.

When the virtual character is in the crouching state, the player can slide the first virtual joystick in the specified direction, and then the virtual character will be immediately switched into the standing state from the crouching state and move in the specified direction in the standing state. The specific direction of the specified direction can be determined according to specific operations of the player. For example, when the player slides the first virtual joystick rightwards, the virtual character will be switched into the standing state from the crouching state, and the virtual character will stand and move rightwards.

Step S514: In response to the sliding operation for the first virtual joystick, control the virtual character to move in the standing state; and perform step S516.

When the virtual character is in the standing state, the player can slide the first virtual joystick to move the virtual character in the standing state according to the sliding direction of the sliding operation.

Step S516: Determine whether the distance between the virtual character and the virtual bunker is greater than the preset distance value; and if it is greater than the preset distance value, perform step S518, otherwise, perform step S516.

Step S518: Cancel the display of the crouch control.

In the process when the virtual character moves in the standing state, the distance between the virtual character and the virtual bunker will be calculated, and whether the distance is greater than a preset distance value is determined; and if the distance is larger than the preset distance value, the display of the crouch control and the second virtual joystick will be canceled; and if the distance is not greater than the preset distance value, whether the distance between the virtual character and the virtual bunker is greater than the preset distance value is continuously determined so as to monitor the distance between the virtual character and the virtual bunker.

According to the game interaction method, the crouch control is displayed only when the player is close to the bunker in the standing state, the player cannot leave a bunker attachment area no matter how the player operates the second virtual joystick; and when the player operates the second virtual joystick in the crouching state, the virtual character will be directly released from the crouching state and enter the standing and moving state. In this way, if the player in the crouching state wants to stand and move, the player can directly operate the first virtual joystick, the operation is smoother, and compared with a mode of clicking the crouch control and then operating and moving the joystick, this mode has the advantages that the operation of moving the virtual character inside and outside the bunker is clear and easy to understand, and moreover, the operation of moving the virtual character in the crouching state to leave the bunker to stand and move is more smoothly.

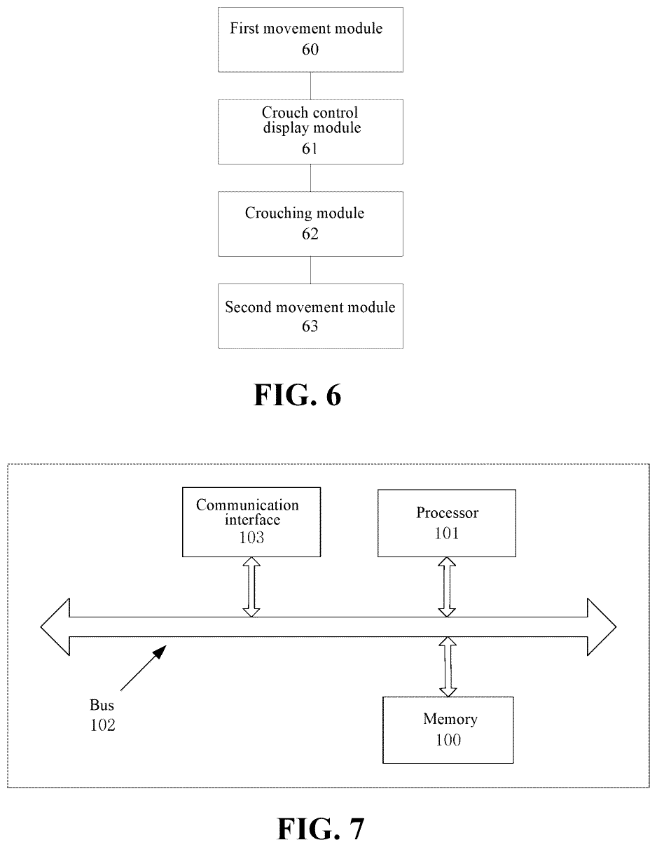

Corresponding to the above method embodiment, an embodiment of the present disclosure provides a game interaction apparatus; a graphic user interface is provided by means of a terminal device, the graphic user interface displaying at least part of a virtual scene and a first virtual joystick as well as a virtual character and a virtual bunker in the virtual scene; as shown in FIG. 6, the apparatus includes:
a first movement module 60 which is configured to: in response to a first touch operation for the first virtual joystick, control the virtual character to move in the virtual scene;
a crouch control display module 61 which is configured to: in response to the fact that a position relationship between the virtual character and the virtual bunker meets a preset condition, display a crouch control in the graphical user interface;
a crouching module 62 which is configured to: in response to a second touch operation for the crouch control, control the virtual character to enter the virtual bunker and crouch, and display a second virtual joystick in the graphical user interface; and
a second movement module 63 which is configured to: in response to a third touch operation for the second virtual joystick, control the virtual character to move in a crouching state.

The game interaction apparatus is configured to: in response to the first touch operation for the first virtual joystick, control the virtual character to move in the virtual scene; then, in response to the fact that the position relationship between the virtual character and the virtual bunker meets the preset condition, display the crouch control in the graphical user interface; in response to the second touch operation for the crouch control, control the virtual character to enter the virtual bunker and crouch, and display the second virtual joystick in the graphical user interface; and in response to the third touch operation for the second virtual joystick, control the virtual character to move in the crouching state. In this way, the virtual character is controlled by means of the first virtual joystick to move in the standing state, and is controlled by means of the second virtual joystick to move around the virtual bunker in the crouching state; when the position or orientation of the virtual character relative to the virtual bunker is changed, operation responses of the first virtual joystick and the second virtual joystick are not changed. Therefore, a misoperation or invalid operation of the player is avoided, and the convenience and interaction efficiency for the player to perform an interaction operation related to the bunker are improved.

Specifically, the second movement module 63 is configured to: control the virtual character to move in the crouching state within a specified range of the virtual bunker.

Further, the apparatus further includes a state switching module which is configured to: when the virtual character is in the crouching state, in response to a fourth touch operation for the first virtual joystick, control the virtual character to switch from the crouching state to the standing state, and control the virtual character to move in the standing state.

In one embodiment, the apparatus further includes a joystick hiding module which is configured to: in response to the virtual character switching from the crouching state to the standing state, hide the second virtual joystick.

In one embodiment, the apparatus further includes a control hiding module which is configured to: in response to the fact that the position relationship between the virtual character and the virtual bunker does not meet the preset condition, hide the crouch control.

Further, the crouching module 62 is further configured to: in response to the second touch operation for the crouch control, switch the crouch control to the second virtual joystick.

Specifically, the second virtual joystick includes a joystick base and a control rod, and the crouch control serves as the control rod.

In some embodiments, the first virtual joystick and the second virtual joystick are displayed on the same side of the graphical user interface.

Further, the first movement module 60 is further configured to: in response to the first touch operation for the first virtual joystick, control the virtual character to move in the virtual scene in the standing state.

The principle of implementation and the technical effect produced of the game interactive apparatus provided by the embodiment of the present disclosure are the same as those of the above method embodiment. For a brief description, the parts not mentioned in the apparatus embodiment may refer to the corresponding content in the above method embodiment.

An embodiment of the present disclosure also provides an electronic device, as shown in FIG. 7, the electronic device includes a processor and a memory that stores machine-executable instructions executable by the processor, and the processor executes the machine-executable instructions to realize the above game interaction method.

Specifically, a graphic user interface is provided by means of the terminal device and displays at least part of the virtual scene and the first virtual joystick as well as the virtual character and the virtual bunker in the virtual scene; the method includes: in response to the first touch operation for the first virtual joystick, controlling the virtual character to move in the virtual scene; in response to the fact that the position relationship between the virtual character and the virtual bunker meets the preset condition, displaying the crouch control in the graphical user interface; in response to the second touch operation for the crouch control, controlling the virtual character to enter the virtual bunker and crouch, and displaying the second virtual joystick in the graphical user interface; and in response to the third touch operation for the second virtual joystick, controlling the virtual character to move in the crouching state.

In the game interaction method, the virtual character is controlled by means of the first virtual joystick to move in the standing state, and is controlled by means of the second virtual joystick to move around the virtual bunker in the crouching state; when the position or orientation of the virtual character relative to the virtual bunker is changed, operation responses of the first virtual joystick and the second virtual joystick are not changed. Therefore, a misoperation or invalid operation of the player is avoided, and the convenience and interaction efficiency for the player to perform an interaction operation related to the bunker are improved.

In one embodiment, the controlling the virtual character to move in a crouching state includes: controlling the virtual character to move in the crouching state within a specified range of the virtual bunker.

In one embodiment, the method further includes: when the virtual character is in the crouching state, in response to a fourth touch operation for the first virtual joystick, controlling the virtual character to switch from the crouching state to a standing state, and controlling the virtual character to move in the standing state.

In one embodiment, the method further includes: in response to the virtual character switching from the crouching state to the standing state, hiding the second virtual joystick.

In one embodiment, the method further includes: in response to the fact that the position relationship between the virtual character and the virtual bunker does not meet the preset condition, hiding the crouch control.

In one embodiment, the in response to a second touch operation for the crouch control, displaying a second virtual joystick in the graphical user interface includes: in response to the second touch operation for the crouch control, switching the crouch control to the second virtual joystick.

In one embodiment, the second virtual joystick includes a joystick base and a control rod, and the crouch control serves as the control rod.

In one embodiment, the first virtual joystick and the second virtual joystick are displayed on the same side of the graphical user interface.

In one embodiment, the in response to a first touch operation for the first virtual joystick, controlling the virtual character to move in the virtual scene includes: in response to the first touch operation for the first virtual joystick, controlling the virtual character to move in the virtual scene in the standing state.

Further, the electronic device shown in FIG. 7 further includes a bus 102 and a communication interface 103; and the processor 101, the communication interface 103 and the memory 100 are connected through the bus 102.

The memory 100 may include a Random Access Memory (RAM), and may also include a non-volatile memory, such as at least one disk memory. Communication connection between a system network element and at least one other network element is realized through at least one communication interface 103 (which can be wired or wireless), and the Internet, a wide area network, a local network, a metropolitan area network and the like can be used. The bus 102 can be an ISA bus, a PCI bus, an EISA bus or the like. The buses can be divided into an address bus, a data bus, a control bus and the like. In order to facilitate representation, only one bidirectional arrow is used for representation in FIG. 7, but it not indicates that there is only one bus or one type of bus.

The processor 101 may be an integrated circuit chip and has the signal processing capacity. In the implementation process, all steps of the method can be implemented through an integrated logic circuit of hardware in the processor 101 or instructions in a software form. The processor 101 can be a universal processor, including a Central Processing Unit (CPU), a Network Processor (NP) and the like; it can also be a Digital Signal Processing (DSP), an Application Specific Integrated Circuit (ASIC), a Field-Programmable Gate Array (FPGA) or other Programmable logic devices, discrete gates or transistor logic devices and discrete hardware assemblies. All the methods, steps and logic block diagrams disclosed in the embodiment can be implemented or executed. The universal processor can be a microprocessor or the processor can also be any conventional processor and the like. The steps of the method disclosed in combination with the embodiment of the present disclosure can be directly embodied as the completion of execution by a hardware decoding processor, or the completion of execution by a combination of hardware and software modules in the decoding processor. The software modules can be located in a random access memory, a flash memory, a read-only memory, a programmable read-only memory or an electrically erasable programmable memory, a register and other mature storage media in the field. The storage media are located in the memory 100, the processor 101 reads information in the memory 100; and the steps of the method in the embodiment are completed in combination with its hardware.

An embodiment of the present disclosure also provides a computer-readable storage medium, the computer-readable storage medium stores computer-executable instructions, and when the computer-executable instructions are invoked and executed by the processor, the computer-executable instructions cause the processor to realize the above game interaction method; and the specific implementation can refer to the method embodiment, which is not listed herein.

Specifically, a graphic user interface is provided by means of the terminal device and displays at least part of the virtual scene and the first virtual joystick as well as the virtual character and the virtual bunker in the virtual scene; the method includes: in response to the first touch operation for the first virtual joystick, controlling the virtual character to move in the virtual scene; in response to the fact that the position relationship between the virtual character and the virtual bunker meets the preset condition, displaying the crouch control in the graphical user interface; in response to the second touch operation for the crouch control, controlling the virtual character to enter the virtual bunker and crouch, and displaying the second virtual joystick in the graphical user interface; and in response to the third touch operation for the second virtual joystick, controlling the virtual character to move in the crouching state.

In the game interaction method, the virtual character is controlled by means of the first virtual joystick to move in the standing state, and is controlled by means of the second virtual joystick to move around the virtual bunker in the crouching state; when the position or orientation of the virtual character relative to the virtual bunker is changed, operation responses of the first virtual joystick and the second virtual joystick are not changed. Therefore, a misoperation or invalid operation of the player is avoided, and the convenience and interaction efficiency for the player to perform an interaction operation related to the bunker are improved.

In one embodiment, the controlling the virtual character to move in a crouching state includes: controlling the virtual character to move in the crouching state within a specified range of the virtual bunker.

In one embodiment, the method further includes: when the virtual character is in the crouching state, in response to a fourth touch operation for the first virtual joystick, controlling the virtual character to switch from the crouching state to a standing state, and controlling the virtual character to move in the standing state.

In one embodiment, the method further includes: in response to the virtual character switching from the crouching state to the standing state, hiding the second virtual joystick.

In one embodiment, the method further includes: in response to the fact that the position relationship between the virtual character and the virtual bunker does not meet the preset condition, hiding the crouch control.

In one embodiment, the in response to a second touch operation for the crouch control, displaying a second virtual joystick in the graphical user interface includes: in response to the second touch operation for the crouch control, switching the crouch control to the second virtual joystick.

In one embodiment, the second virtual joystick includes a joystick base and a control rod, and the crouch control serves as the control rod.

In one embodiment, the first virtual joystick and the second virtual joystick are displayed on the same side of the graphical user interface.

In one embodiment, the in response to a first touch operation for the first virtual joystick, controlling the virtual character to move in the virtual scene includes: in response to the first touch operation for the first virtual joystick, controlling the virtual character to move in the virtual scene in the standing state.

If the function is implemented in a software function unit mode and is sold or used as an independent product, it can be stored in a computer-readable storage medium. Based on this understanding, the essence of the disclosed technical solution or the part that contributes to the prior art or the part of the technical solution may be embodied in the form of a software product, and the computer software product is stored in a storage medium and includes a plurality of instructions used for enabling one computer device (which can be a personal computer, terminal device or network equipment and the like) to execute all or part of the steps of the method of all the embodiments of present disclosure. The storage medium includes a USB flash disk, a mobile hard disk, a Read-Only Memory (ROM), a Random Access Memory (RAM), a disk or an optical disk and other media capable of storing program codes.

In the description of the present disclosure, it is to be noted that the terms “center”, “up”, “down”, “left”, “right”, “vertical”, “horizontal”, “inner”, “outer”, etc., indicate the orientation or positional relationship based on the orientation or positional relationship shown in the drawing, and are only for the convenience of description of the present disclosure and for the purpose of simplifying the description, and do not indicate or imply that the device or element referred to must have a specific orientation, be constructed and operated in a particular orientation, and therefore cannot be construed as limiting the present disclosure. In addition, the terms “first”, “second”, “third” are used for descriptive purposes only and should not be construed as indicating or implying relative importance.

Finally, it is to be noted that the above-mentioned embodiments are only specific embodiments of the present disclosure, which are used for illustrating the technical solutions of the present disclosure, not to limit them, and the scope of protection of the present disclosure is not limited to this. Although the present disclosure is described in detail with reference to the above embodiments, a person of ordinary skill in the art should understand that any person skilled in the art who is familiar with the art can still modify the technical solutions described in the aforesaid embodiments or can easily think of changes or equivalent substitutions of some of the technical features within the scope of the technology disclosed in the disclosure; however, these modifications, changes or substitutions do not depart from the essence of the corresponding technical solution from the spirit and scope of the technical solution of the embodiments of the present disclosure, and shall be covered by the scope of protection of the present disclosure. Therefore, the scope of protection of this disclosure should be based on the scope of protection of the claims.

1. A game interaction method, the method comprises:
in response to a first touch operation for a first virtual joystick, controlling a virtual character to move in a virtual scene, wherein a graphic user interface of a terminal device displays at least one of the virtual scene and the first virtual joystick, and the virtual scene comprises the virtual character and a virtual bunker;
in response to determining that a position relationship between the virtual character and the virtual bunker meets a preset condition, displaying a crouch control in the graphical user interface;
in response to a second touch operation for the crouch control, controlling the virtual character to enter the virtual bunker and crouch within the virtual bunker, and displaying a second virtual joystick in the graphical user interface; and
in response to a third touch operation for the second virtual joystick, controlling the virtual character to move in a crouching state.

2. The method according to claim 1, wherein the controlling the virtual character to move in the crouching state comprises:
controlling the virtual character to move in the crouching state within a specified range of the virtual bunker.

3. The method according to claim 1, further comprising:
in response to a fourth touch operation for the first virtual joystick, controlling the virtual character to switch from the crouching state to a standing state; and
controlling the virtual character to move in the standing state.

4. The method according to claim 3, further comprising:
in response to the virtual character switching from the crouching state to the standing state, hiding the second virtual joystick.

5. The method according to claim 1, further comprising:
in response to determining that the position relationship between the virtual character and the virtual bunker does not meet the preset condition, hiding the crouch control.

6. The method according to claim 1, wherein in response to the second touch operation for the crouch control, displaying the second virtual joystick in the graphical user interface comprises:
in response to the second touch operation for the crouch control, switching the crouch control to the second virtual joystick.

7. The method according to claim 1, wherein the second virtual joystick comprises a joystick base and a control rod, and the crouch control serves as the control rod.

8. The method according to claim 1, wherein the first virtual joystick and the second virtual joystick are displayed on a same side of the graphical user interface.

9. The method according to claim 1, wherein in response to the first touch operation for the first virtual joystick, controlling the virtual character to move in the virtual scene comprises:
controlling the virtual character to move in the virtual scene in a standing state.

10. (canceled)

11. A system, comprising:
one or more memories collectively containing one or more programs; and
one or more processors, wherein the one or more processors are configured to, individually or collectively, perform an operation comprising:
in response to a first touch operation for a first virtual joystick, controlling a virtual character to move in a virtual scene, wherein a graphic user interface of a terminal device displays at least one of the virtual scene and the first virtual joystick, and the virtual scene comprises the virtual character and a virtual bunker;
in response to determining that a position relationship between the virtual character and the virtual bunker meets a preset condition, displaying a crouch control in the graphical user interface;
in response to a second touch operation for the crouch control, controlling the virtual character to enter the virtual bunker and crouch within the virtual bunker, and displaying a second virtual joystick in the graphical user interface; and
in response to a third touch operation for the second virtual joystick, controlling the virtual character to move in a crouching state.

12. One or more non-transitory computer-readable storage media containing, in any combination, computer program code that, when executable by a computer system, perform an operation comprising:
in response to a first touch operation for a first virtual joystick, controlling a virtual character to move in a virtual scene, wherein a graphic user interface of a terminal device displays at least one of the virtual scene and the first virtual joystick, and the virtual scene comprises the virtual character and a virtual bunker;
in response to determining that a position relationship between the virtual character and the virtual bunker meets a preset condition, displaying a crouch control in the graphical user interface;
in response to a second touch operation for the crouch control, controlling the virtual character to enter the virtual bunker and crouch within the virtual bunker, and displaying a second virtual joystick in the graphical user interface; and
in response to a third touch operation for the second virtual joystick, controlling the virtual character to move in a crouching state.

13. The system according to claim 11, wherein controlling the virtual character to move in the crouching state comprises:
controlling the virtual character to move in the crouching state within a specified range of the virtual bunker.

14. The system according to claim 11, wherein the operation further comprises:
in response to a fourth touch operation for the first virtual joystick, controlling the virtual character to switch from the crouching state to a standing state; and
controlling the virtual character to move in the standing state.

15. The system according to claim 14, wherein the operation further comprises:
in response to the virtual character switching from the crouching state to the standing state, hiding the second virtual joystick.

16. The system according to claim 11, wherein the operation further comprises:
in response to determining that the position relationship between the virtual character and the virtual bunker does not meet the preset condition, hiding the crouch control.

17. The system according to claim 11, wherein in response to the second touch operation for the crouch control, displaying the second virtual joystick in the graphical user interface comprises:
in response to the second touch operation for the crouch control, switching the crouch control to the second virtual joystick.

18. The system according to claim 11, wherein the second virtual joystick comprises a joystick base and a control rod, and the crouch control serves as the control rod.

19. The system according to claim 11, wherein the first virtual joystick and the second virtual joystick are displayed on a same side of the graphical user interface.

20. The system according to claim 11, wherein in response to the first touch operation for the first virtual joystick, controlling the virtual character to move in the virtual scene comprises:
controlling the virtual character to move in the virtual scene in a standing state.

21. The system according to claim 11, wherein the first virtual joystick and the second virtual joystick are displayed on different sides of the graphical user interface.
